(19) United States
(12) Patent Application Publication
(10) Pub. No.: US 2017/0197139 A1
(43) Pub. Date: Jul. 13, 2017

(54) Educational Board Game

(71) Applicant: Verleen Krystle McSween, Bloomington, IN (US)

(72) Inventor: Verleen Krystle McSween, Bloomington, IN (US)

(21) Appl. No.: 14/993,817

(22) Filed: Jan. 12, 2016

(51) Int. Cl. A63F 3/04; G09B 19/00; G09B 3/02

(52) U.S. Cl. CPC A63F 3/04; A63F 3/0449; A63F 3/0457; G09B 3/02; G09B 19/00

(57) ABSTRACT

The present invention provides an educational and entertaining board game for imparting biblical, anthropological, and archaeological knowledge. The board game provides a game board with a landscape, highlighting biblical, anthropological, and archaeological events and facts. The board game also provides a plurality of cards that have various characteristics for engaging the player in a variety of activities during the game. The plurality of cards includes trivia cards, which, when answered correctly, allow a player to advance over a path provided through the landscape on the gameboard, command cards, which confer tasks to perform or privileges on players, and cards providing artifacts, resources, and points, which are collected, shared, or traded during the play to win the game. Various cards of the board game provide different characters and characteristics to the players.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of Invention

The present invention generally relates to an educational and entertaining board game.

More particularly, the present invention relates to “a board game for imparting biblical, archaeological, and anthropological knowledge in an entertaining manner with the help of various game elements”.

(2) Background of Invention

Games can speed up the learning process, as well as make it entertaining. Biblical knowledge is imparted to kids and adults by reading the Bible and discussing it. The Bible is a revered book, but kids and people do not read it often. Therefore, many people do not have good knowledge of the teachings from the Bible. Hence, its information is not learned well. Games on biblical information can help this learning process. Similarly, anthropology and archaeology reveal many important findings about past civilization. This information also forms an important part of learning. Similar to biblical information, information from anthropology and archeology can be learned in an entertaining manner with the help of games. Many games have been designed for enhancing knowledge of the Bible, anthropology, and archaeology. Board games are very popularly played for entertainment and education. Board games, in general, provide a theme of progression of the game while employing certain rules and criteria to add difficulty and entertainment during the progress of the game. For example, U.S. Pat. No. 5,042,816 A, issued to Davis Tracy L and Cimakasky Richard R on 1991, Aug. 27, discloses an educational and entertaining board game for teaching players about the Bible. When the player answers a question from the Bible correctly, he is able to move his game pieces. Similarly, U.S. Pat. No. 5,071,133 A, issued to Jerry I Smith on 1991, Dec. 10, discloses a game played by rolling dice to move pieces on a game board while imparting knowledge about the teachings of the Bible. Similarly, U.S. Pat. No. 5,377,991 A, issued to M. Ardell Olsen on 1995, Jan. 03, discloses a board game using a circular track where the movement of a player's game piece depends on the player's knowledge of the Book of Mormon. Similarly, U.S. Pat. No. 7,198,271 B1, issued to Darryl Thomas on 2007, Apr. 03, discloses a board game involving the use of a categorized knowledge store for theology, biblical, or thematic knowledge. The player moves through a plurality of defined spaces on a game board. The game also uses a supplemental store and tokens. Most of these games are specific to only biblical, anthropological, or archaeological knowledge, or only include their knowledge as part of a general knowledge bank. Furthermore, many of these games do not entertain and engage players well. Hence, it is desired that a board game be provided that uses knowledge of the Bible, anthropology, and archaeology to provide a good learning experience. Furthermore, it is desired that the game includes various elements that make the game more entertaining and engaging.

It is an aspect of the invention to overcome or alleviate a problem of the prior art.

This permits the use of the present invention, which enhances the prior art of board games for providing an educational and entertaining tool for teaching biblical, anthropological, and archaeological knowledge.

### BRIEF SUMMARY OF THE INVENTION

In view of the foregoing, one aspect of the various disclosed embodiments in the present invention is to provide a novel educational and entertaining board game for imparting biblical, archaeological, and anthropological knowledge, with help of various game elements.

Preferably, the educational and entertaining board game addresses, or at least ameliorates, one or more of the problems described above. To this end, the present invention, related to an educational and entertaining board game with some unique aspects, is disclosed.

Accordingly, it is a primary objective of the present invention to provide an educational and entertaining board game for imparting biblical, archaeological, and anthropological knowledge. The board game includes a game board, a pair of dice, various types of cards with differing characteristics, and tokens for obstacles. The board game also provides different characters and different characteristics to a player. The board game can be played by multiple players. Different players can choose from different characters and characteristics to play the board game.

It is another objective of the present invention that, during the board game, a player collects artifacts and scores points. Further, the player with the most artifacts or the most points wins.

It is yet another objective of the present invention to provide a gameboard for playing the board game of the present invention. The gameboard has a landscape printed on it. The landscape has different tracks for a player to progress through during play. The game board can have different types of landscapes. A track is made of a plurality of spaces of different colors that are chosen from a set of colors.

It is yet another objective of the present invention to provide different types of cards for playing the game. Each of the cards has a color chosen from the set of colors used for spaces on the track on the game board. The cards provide different characteristics to the game and players. The cards may include trivia, character identification, command, and other themes for imparting knowledge about the Bible, anthropology, and archaeology. They also make the game more entertaining and engaging.

Other objectives of the present invention will become apparent, from time to time, throughout the specification, as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing in which:

FIG. 1 shows an exemplary representation of a game board.

FIG. 2 shows a perspective view of the format for back of a card.

FIG. 3 shows an exemplary representation of a command card.

FIG. 4 shows an exemplary representation of another command card.

FIG. 5 shows an exemplary representation of a “Who Am I?” card.

FIG. 6 shows an exemplary representation of a trivia card.

FIG. 7 shows an exemplary representation of another trivia card.

### DETAIL DESCRIPTION OF THE INVENTION

The following detailed description of the present invention enables teaching of the invention and its best, currently known embodiment. Those skilled in the art can understand that many changes can be made to the embodiments described, while still obtaining beneficial results of the present invention. It will also be apparent that some of the desired benefits of the present invention can be obtained by selecting some of the features of the invention, while not utilizing other features. Accordingly, those working in the relevant art will recognize that many adaptations and modification to the present invention can be made, may be desired in certain circumstances, and are part of the present invention. Thus, the following description is provided as illustrative of the principle of the present invention.

Embodiments of the present invention provide an educational and entertaining board game for imparting biblical, archaeological, and anthropological knowledge with the help of various game elements. Accordingly, the specific embodiments discussed herein are merely illustrative of specific manners in which to make and use this invention, and are not intended to represent an exhaustive list of all possible structures and processes of the present invention.

Embodiments of the method are shown in the figures, and discussed below. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification.

Aspects of the present inventive subject matter are described with reference to the figures provided herein.

The present invention provides an educational and entertaining board game for imparting biblical, archaeological, and anthropological knowledge with the help of various game elements. The intent of the game is not only educational, but also fun, and promotes social interaction while learning. The game design features a multi-player design that allows player to be competitive, but also encourages collaboration between different players. The game can be played by two to six players. Furthermore, the game provides the players with different characters to choose from. Each character has unique strengths and tokens for obstacles. The game employs a game board that has a landscape imprinted on it, where the landscape has a plurality of tracks. Each track is made of a plurality of spaces, on which the player progresses during the course of the board game. Each of the spaces has a color chosen from a set of colors. The game can be played with different landscapes. The game also includes a plurality of cards of colors chosen from the set of colors used for coloring the space. These cards allow players to participate in different activities in order to advance in the game. Some of the cards provide trivia, such as interesting questions on biblical facts or narratives that the players use to advance when answered correctly. A dice with a top face is used in the game. Once the dice is rolled and a number on the top face is obtained, the player has to move the same number of spaces on a track as the number appearing on the top face of the dice. The color of the new space occupied by the player is the color of the card which the player has to choose from the plurality of the cards. The chosen card, then guides the next activity in the game. The progress on the tracks is dependent on a player's ability to answer questions related to the Bible, archaeology, and anthropology. In a preferred embodiment, the board game is primarily a faith-based board game that incorporates archaeology and anthropology. The game includes a compilation of relevant archaeological discoveries that support and confirm the biblical narratives found in the Bible. The compilation includes reliable archaeological sources and color photos of archaeological findings, in addition to well-illustrated graphics for the game board and player cards. The compilation is presented in an easy to follow and accessible format for the non-archaeologist or history expert. The game features different elements that keep the game uncomplicated, although unpredictable, which enhances the player's interest and participation. The use of the game is versatile and can be adapted to meet player's needs. The game can be used in a variety of formats or settings, such as in a classroom, home, church, or other religious meeting, in order to enhance player knowledge of the subject matter or for enjoyment. The game is useful for family entertainment, or as an educational tool.

### Game Board:

The gameboard employed to play the board game of the present invention is made of a quality cardboard-type material that is typical of board games. The game board can be provided in different shapes and sizes. In a preferred embodiment, the design of the game board is circular. In a preferred embodiment, the diameter of the board is 18 inches, and the circumference is 56.55 inches.

The present invention provides different types of landscapes for use in the game. A game board has one of the different landscapes provided by the present invention. The landscape is printed onto the game board. The different landscapes include, but are not limited to, ‘Pathway through the Red Sea’, ‘Desert/Wilderness’, ‘Desert Oasis’, ‘Ancient Ruins’, ‘Agricultural/Farmland’, ‘Cities’, ‘Pyramids and Nile River’, ‘Open Sea’, ‘Enemy Territory/Battlefields’, ‘Mountainous Region’, and ‘Nomadic Settlement Camp’. The tracks on the gameboard have several different colors.

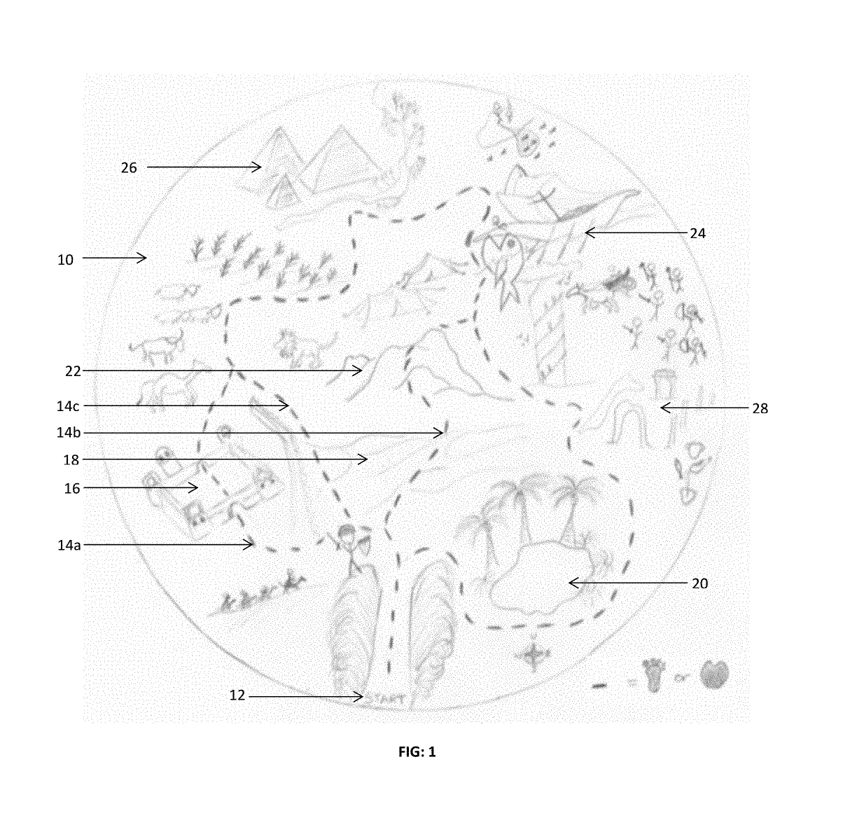

FIG. 1 shows an exemplary representation of a game board that is used in the board game of the present invention. The game board 10 is circular and has a landscape printed on it. The landscape shows a start 12 and a plurality of tracks 14a, 14b, 14c for players to take. Furthermore, the landscape shows castles 16, deserts 18, islands 20, mountains 22, seas 24, pyramids 26, and archaeological and historical sites 28 for engaging the players in different activities during the course of the game.

### Players:

In the game, players have different characters to choose from, such as, but not limited to, graduate student, historian, teacher, doctor, soldier, etc. Each character will have unique strengths and token for obstacles. Players select cards at random that confer different characteristics.

Player characteristics may include:

Job description/profession—e.g. Archaeologist, or tourist

Country of origin/nationality

Monetary allowance—ancient currency, e.g. the shekel

Mode of transportation—e.g. motor vehicle, or camel

Food resources—e.g. grain, oil

Access to other helpful resources—e.g., translator, map, or native guide

### Cards:

The board game of the present invention includes a plurality of cards. The cards are made of a light card stock material, and are approximately 3.5 inches long and 2.5 inches wide. Different types of cards are used in the game. The cards may display questions, instructions, or phrases. Some of the exemplary cards include, but are not limited to, ‘command cards’, ‘Who Am I? cards’, ‘Trivial cards’, ‘Resource cards’, and ‘Artifact cards’.

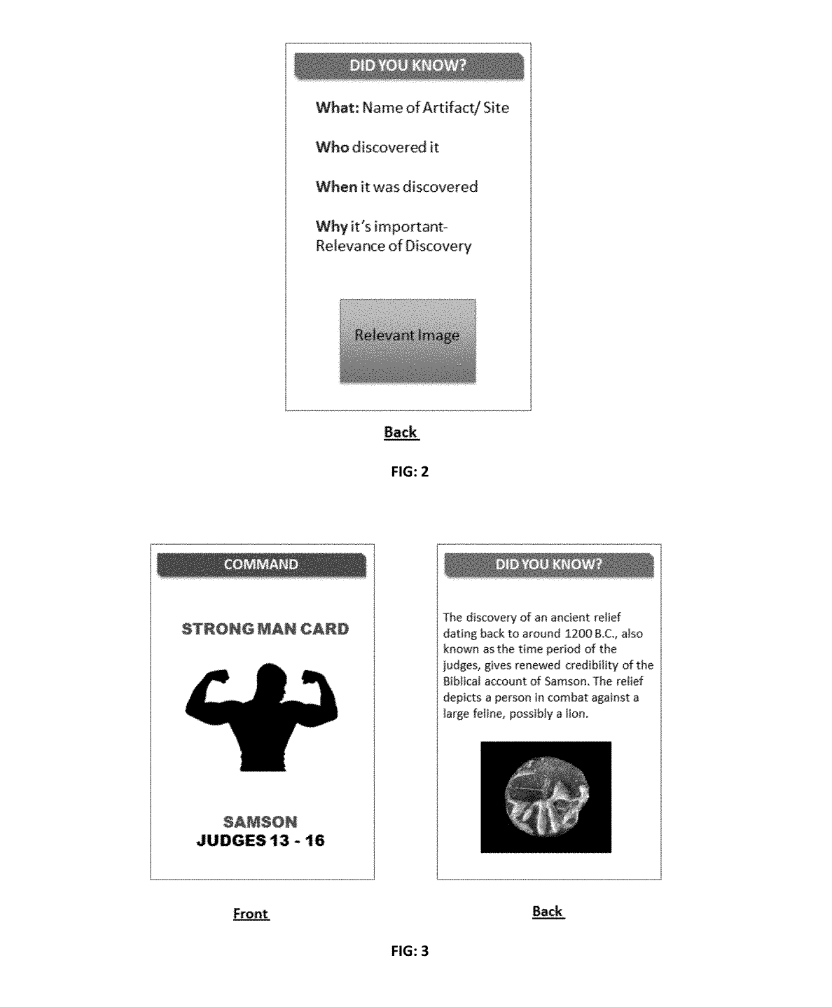

There will be a front and back side to each card for most of the cards used in the game, including but not limited to ‘Command cards’, ‘Who Am I? cards’, and ‘Trivia cards’. The front side will have the category of the activity and the activity to be performed or the question to be answered. FIG. 2 shows the back side of a card. The back side has an interesting and relevant archaeological fact. The back side of the card is organized in a condensed, standard format for engaging the players.

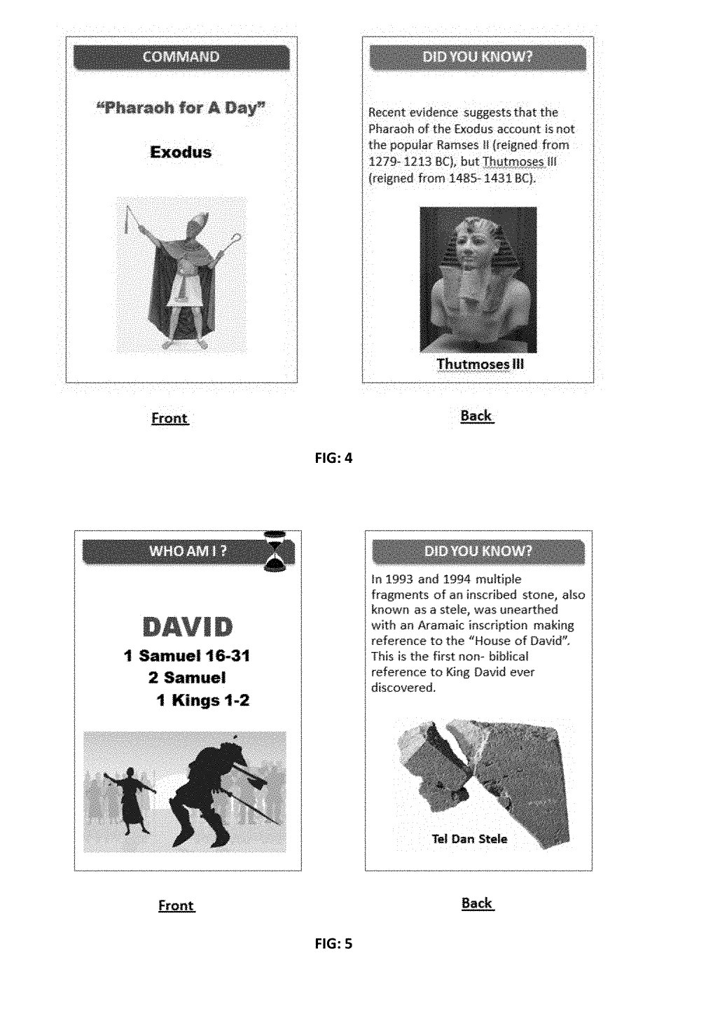

Command cards: These cards contain activities or tasks that players are required to perform, or give players special abilities or privileges that other players do not have. For example: “Strong man card” may allow a player to get out of a difficult situation or advance prematurely, relative to other players. FIG. 3 shows an exemplary representation of a “Strong man card” for Samson. The back side of the card tells archaeological facts about Samson. Similarly, the “Pharaoh for a Day” card allows the current player to ignore any command cards for one round, as well as “order around” other players for one round. The “Camel Stop” card commands everyone in the game (who has a camel as a resource) to give his or her camel a rest and water break, i.e. the players miss one turn. FIG. 4 shows an exemplary representation of a “Pharaoh for a Day” for Pharaoh of the Exodus, the back side of the card tells archaeological facts based about the Pharaoh of the Exodus.

“Who Am I?” cards: These cards contain the name of a Biblical character. The player must use charades or a drawing to help the other players identify the Biblical character listed on the card. The hourglass signifies activities that have a time constraint. So, a question from a “Who Am I?” card with hourglass is to be answered within a time limit. The board game may provide a timer for this purpose. FIG. 5 shows an exemplary representation of a “Who Am I?” card about King David. The back side of the card tells archaeological facts about King David and “House of David”.

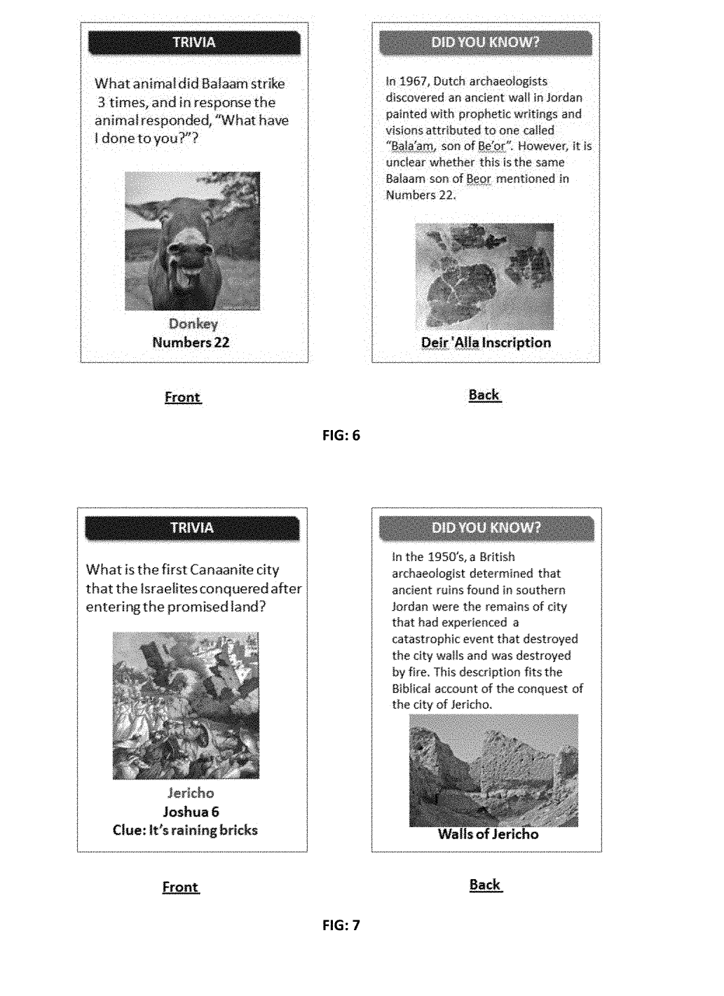

Trivia cards: These cards contain questions that players must answer in order to advance. The questions can occur in different formats, such as but not limited to ‘True and False’, ‘multiple choices’, etc. Some cards may contain clues to assist players. The level of difficulty of the questions and other activities will vary in order to accommodate the age range of players. The type and difficulty level of the questions vary, to accommodate players of different ages (ages 7 and above). FIGS. 6 and 7 show exemplary representations of trivia cards. The front side of the card shows a biblical question and clues to solve the question, while the back side of the card shows archaeological facts about the subject of the biblical question.

Resource Cards: There will be separate cards for resources. They can be traded or shared throughout the game with other players.

Artifact cards: Additionally, there will also be artifact cards that players can collect for points or value. Artifact cards may be part of a set of two or three artifact cards representing a different artifacts category. Players may need to collect all of the cards to complete the set. Artifacts can also be traded with other players for their artifacts, or for resources. Artifacts can include, but are not limited to, ancient scrolls, pottery, jewelry, carvings, wall paintings, and hieroglyphic markings.

### Tokens:

The board game of the present invention includes various player tokens, such as camel, warrior, bow and arrow, shepherd's rod, pyramid, and the like.

Other resources:

The game may include a good compilation of reliable archaeological sources and color photos of archaeological findings. Interesting questions on biblical facts or narratives will also enhance player interest.

### Game Rules:

To play the game, players roll dice and move across the game board the same number of spaces as indicated by the dice. The track that the players follow will have several different colors. Each color represents a different type of card to be selected, for e.g., command card, trivia card, “who Am I?” card, etc. The selected card guides the next event of the game before the next rolling of the dice.

If a Trivia card or “Who Am I?” card is selected, the player must read the card to the entire group and whoever answers the question correctly (and first) gets to collect one artifact from a random assortment of artifact cards. If players are unable to answer the question, a biblical reference is provided for added assistance. Players can search for the Bible reference in order to find the correct answer.

If a command card is selected, the player may use the card right away or save the card for a later turn, where the card might prove useful. The command card may contain a useful attribute that can be used as an advantage over other players, such as strength, or it may contain activities that the current player is required to perform. Command cards will also contain exemptions made for those with specific player characteristics.

The next player to roll the dice will be the individual to the left of the first player to roll the dice. Similarly, he/she will roll the dice, move along the track, and select the appropriate card based on the color-coded system.

Players try to collect as many artifacts as they can by answering questions correctly or completing any indicated tasks. Participants also search for artifacts from lost civilizations, including Israel, and use archaeological tools or equipment to decipher ancient messages that have ancient scripture on them. These can add to their collection of archaeological artifacts. The ancient messages might be clues that help them get ahead. The artifacts collected can be kept for added points or traded with another collector for resources, or for other artifacts. For example, there may be a set of artifacts that go together, and it would be advantageous to have all the members of one set. Players might also be challenged to go through mazes of ancient cities, such as Jerusalem, or escape Jericho before the walls fall.

At the end of the game, the player that collects the most artifacts wins; however, more points are given to a player that collects a complete set of artifacts. Different artifact cards will have different points of value, and two extra points will be added if a set is complete.

As mentioned earlier, the back of most game cards will contain an Archaeological discovery that is relevant to the subject matter on the front of the card. Players may choose to read the information right after their turn, or collect cards until the end of the game, and then go through the information together. Furthermore, each question or activity has a Bible verse that can serve as reference help for a less knowledgeable player.

Additionally, players may choose to share resources and artifacts with another player, such as a camel ride or the use of a translator. However, players (who are in need and would like to share with a player that has a particular resource) are required to trade either a current resource that they do have or an artifact that they possess. In some embodiments, the game may include command cards that allow players the choice of teaming up so they can share resources (for e.g. sharing a camel ride or a translator). This way, a disadvantaged player may have an opportunity to get ahead for a round or two. For example, if a command card says, “‘Tower of Babel’—All players who lack a translator must miss one turn.” A disadvantaged player can ask to share the translator with another player in exchange for an artifact.

### Scenarios:

There can be numerous scenarios in the game based on the different characteristics of player, cards, landscapes, etc. Some of the exemplary scenarios include:

Different players have different modes of transportation selected at random, e.g. Camel/walking/jeep. Some players get an advantage of moving more quickly through the game, but the advantage is sometimes a disadvantage because they may miss a turn or two because there camel may need rest or a water break, or the jeep may run out of gas, and the supply needs to be replenished.

Because players have different characteristics, e.g., nationality, this may come into play if the Israeli immigration office picks them up, and their tourist visas, passport, or documents are out of order. They may have to miss a turn (because they are in prison), or get sent back down the board (for example to re clear customs). Some players will have resources that others don't have, such as a translator or native guide, that can help them get clues or identify shortcuts. Players may also have a set amount of money or resources to trade with one another, like at local markets in the region (for e.g. wine, oil, grain—major crops in ancient Israel). Unplanned events, such as sandstorms, heat strokes, desert mirages, or random skirmishes between ancient Israel and the Amalekites, might cause the player to be delayed or forced to take a detour.

A player may be taken captive by idol worshippers who would like to sacrifice a player to their deities, which causes the player to miss one round. Similarly, the player may be taken captive in an ancient Egyptian invasion of Israel, encountering the giant Goliath, and having to face off with him. The player could receive a fruit from the Tree of Life, so a player may get an extra turn or recover quickly from an illness or injury. The player may meet with nomadic shepherd herders that give the player free resources, such as wool or milk. There may be an arranged marriage with the local sheik/chief's daughter or son, which one can accept or refuse. If the player accepts, the player may have to use up extra resources for two people instead of one, but the player receives a costly dowry, which results in increased funds. If the player refuses, the player has to go back two spaces down the board because the local chief would not allow the player to pass through his territory.

It is to be understood that the above description is intended to be illustrative, and not restrictive. For example, the above discussed embodiments may be used in combination with each other. Many other embodiments will be apparent to those of skill in the art upon reviewing the above description.

Plural instances may be provided for components, operations, or structures described herein as a single instance. Finally, boundaries between various components, operations, and elements are somewhat arbitrary, and particular operations are illustrated in the context of specific illustrative configurations. Other allocations of functionality are envisioned, and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An educational and entertaining board game for imparting biblical, archaeological, and anthropological knowledge, the board game comprising:
a gameboard that has a landscape printed thereon, said landscape comprising a plurality of tracks. Each of said tracks is comprised of a plurality of spaces, each of said spaces has a color chosen from a set of colors;
a dice with a top face, said dice when rolled shows a number on top face of said dice indicating to advance a number of spaces on one of said tracks same as said number on top face of said dice;
a plurality of cards, each of said cards has a color chosen from set of colors of said spaces, said colors comprising first color and second color, a card of color matching the color of currently occupied space after advancing on said track is selected from said cards, selected card guides next event of said board game before next rolling of dice, said plurality of cards comprising
a plurality of trivia cards of first color, each of said plurality of trivia cards consisting a front side and a back side, said front side presenting a question, said back side presenting an archaeological fact related to the subject of said question;
a plurality of command cards of second color, each of said plurality of command cards consisting a front side and a back side, said front side presenting a subject chosen from biblical, archaeological or anthropological knowledge, said back side presenting an archaeological fact related to said subject;
a plurality of “Who Am I?” cards, each of said “Who Am I?” cards consisting a front side and a back side, said front side provides name of a biblical character, said back side provides archaeological fact about said biblical character
a plurality of artifacts cards, each of said artifact cards has an artifact related to the Bible, archeology or anthropology;
a plurality of resource cards; and
a plurality of tokens including camel, warrior, bow and arrow, shepherd's rod, pyramid, and the like.

2. The board game of claim 1, wherein said cards confers different character and characteristics to a player.

3. The board game of claim 1, wherein said board game further comprises a timer.

4. The board game of claim 1, wherein collecting an artifact card earns points.

5. The board game of claim 1, wherein said resource cards are traded or shared.

6. The board game of claim 1, wherein said artifact cards further comprises a multiple set of artifact cards, each of said set of artifact cards representing a different artifact category.

7. The board game of claim 5, wherein collecting a complete set of artifact cards earns extra points.

8. The board game of claim 1, wherein said trivia cards have a clue for question on said front side.

9. The board game of claim 1, wherein said subject of said command cards provides a task to perform.

10. The board game of claim 1, wherein said subject of said command cards provides a privilege.

11. The board game of claim 1, wherein said resource cards are traded or shared.

12. The board game of claim 1, wherein an artifact card is earned when a question about the biblical character of said “Who Am I?” card is correctly answered.

13. The board game of claim 1, wherein the question about the biblical character of said “Who Am I?” card is to be answered within a defined time limit.

14. The board game of claim 1, wherein the player with the maximum number of collected said artifacts wins.

15. The board game of claim 1, wherein the player with the maximum number of points earned wins.
